(19) United States
(12) Patent Application Publication
(10) Pub. No.: US 2013/0213444 A1
(43) Pub. Date: Aug. 22, 2013

(54) Tractor Lawn Mower Washer

(71) Applicant: John W. Zabel, Greenwood, IN (US)

(72) Inventor: John W. Zabel, Greenwood, IN (US)

(21) Appl. No.: 13/401,246

(22) Filed: Feb. 21, 2012

(51) Int. Cl. B08B 3/02

(52) U.S. Cl. 134/123

(57) ABSTRACT

A cleaning device for cleaning grass and debris from the under deck region of a tractor lawn mower after use including a water conduit and a stabilization means.

### FIELD OF THE INVENTION

The present invention relates to a device for cleaning tractor lawn mowers. In particular, the invention relates to cleaning grass and other debris from the under deck area of tractor lawn mowers after use to cut grass.

### BACKGROUND OF THE INVENTION

Removing grass and other debris from the underside of a lawn mower after use is generally desirable for maintaining peak performance of the mower. A variety of devices are known that perform this function including those that attach to the housing of the lawn mower and spray water onto the cutting blades, and other types that spray water directly on the underside of the lawn mower housing.

Tractor lawn mowers generally present greater challenges in this regard than do push mowers. For example, tractor mowers have multiple blades and, owing to their size, are more difficult to maneuver for cleaning the under deck area following use. Unlike single-blade push mowers, which are reasonably easy to turn on a side for cleaning, tractor lawn mowers are considerably more cumbersome to manipulate in order to access the under deck region for cleaning. While the prior art teaches devices for cleaning grass and other debris from the underside of single-blade push mowers (See e.g. U.S. Pat. Nos. 3,856,028, 5,651,242, & 5,027,590) and tractor lawn mowers (See e.g. U.S. Pat. No. 5,673,856 & 6,260,340), such devices are limited both in their effectiveness and, in some cases, their safety during use.

U.S. Pat. No. 5,673,856 describes an undercarriage tubular cleaning device for use on tractor mowers. With the engine running, a mower is driven over the device which includes an axially positioned row of water outlet orifices that direct a plurality of vertical streams of water underneath the deck. The '856 device is placed on the grass during use and is held in place by a stake in the ground.

U.S. Pat. No. 3,856,028 discloses a mower cleaning apparatus that uses a circular housing for directing water upward to the underside of the mower housing to remove cut grass.

There remains a need for a safer, more effective device for cleaning grass and debris from the under deck area of tractor lawn mowers.

### SUMMARY OF THE INVENTION

Certain variations of the invention provide an improved device and method for cleaning the under deck area of a tractor lawn mower after use to cut grass.

In one embodiment of the invention, a mower cleaning device comprises a water conduit for delivering a plurality of pressurized water streams to the under deck area of a tractor mower after use to cut a lawn.

In another embodiment, the device comprises a water conduit for delivery of a plurality of pressurized water streams to the under deck area of a tractor mower, and a stabilization means that supports and stabilizes the device for safe and effective cleaning of the mower after use.

Accordingly, it is an object of the present invention to provide a convenient, safe, and inexpensive way to clean grass and other debris from the under deck area of a tractor lawn mower following use.

These and other objects and advantages of the present invention will be apparent from the following description, the accompanying drawings, and the appended claims.

### BRIEF DESCRIPTION OF THE DRAWINGS

FIG. 1a shows a top view of a multi-beam frame embodiment of the present invention.

FIG. 1b shows a top view of a water conduit of the embodiment of FIG. 1a.

FIG. 1c shows a cross-sectional view of a water conduit of FIG. 1b.

FIG. 2a shows a perspective view of a single-beam frame embodiment of the present invention.

FIG. 2b shows a top sectional view of a single-beam embodiment of FIG. 2a.

FIG. 3 shows a top view depicting a tractor lawn mower in position for cleaning over a multi-beam embodiment of FIG. 1a.

FIG. 4a shows a front view schematic of a tractor mower deck lowered onto a device of the invention.

FIG. 4b shows a front view schematic of a tractor mower deck prior to being lowered onto a device of the invention.

### DESCRIPTION OF PREFERRED EMBODIMENTS

The exemplary embodiments described herein are meant to be illustrative and not limiting to the scope of the invention. Those skilled in the art will appreciate that various modifications, additions, substitutions are possible without departing from the scope and spirit of the invention as described.

As used herein, the terms “mower deck” or “mower deck housing” refer to that part of a tractor mower that houses the cutting blades.

As used herein, the terms “under deck” or “under carriage” refer to that region of a tractor mower that lies beneath the mower deck. In reference to use of the invention described herein to clean the mower after use to cut grass, the term may also include a grass chute component of the deck area.

The present invention relates generally to a tractor lawn mower under deck cleaning device. In one aspect, the device comprises a water channeling means or conduit for delivering pressurized water to the under deck area of the mower to clean away grass and other debris. Water channeling means include any suitable hollow tube or conduit, for example a pipe, tube, hose, or the like that is adapted to connect to a garden hose and home water supply. The water channeling means comprises a plurality of water outlet holes. When pressurized water is delivered to the water conduit, a plurality of pressurized water streams is delivered from the outlet holes, vertically and/or angularly upward to the under deck area of a mower. It is desirable to maintain sufficient pressure in the water streams to enable a thorough cleaning within a reasonable time period. The pressure can be increased or decreased by modifying the number and/or position of the outlet holes and/or by increasing or decreasing the diameter of the outlet holes.

In another aspect, a cleaning device of the invention further comprises a stabilization means for ensuring that the position of the device is substantially stable during use and that safe operation can be maintained. This feature is particularly important both for safety and for achieving a thorough under deck cleaning. Safety concerns are important to consider since the device is designed to be used while positioned beneath the mower with the blades spinning. The stabilization means of a device of the invention is designed to use the weight/mass of the mower to maintain a stable, safe position between the mower and the device when in use.

In embodiments of this aspect of the invention, the top of the cleaning device comes in contact with the bottom edge of the mower deck when the deck is lowered onto the device during use. This configuration utilizes the mass of the mower to create a downward force on the cleaning device such that its position is substantially fixed, at a safe distance from the spinning blades during use.

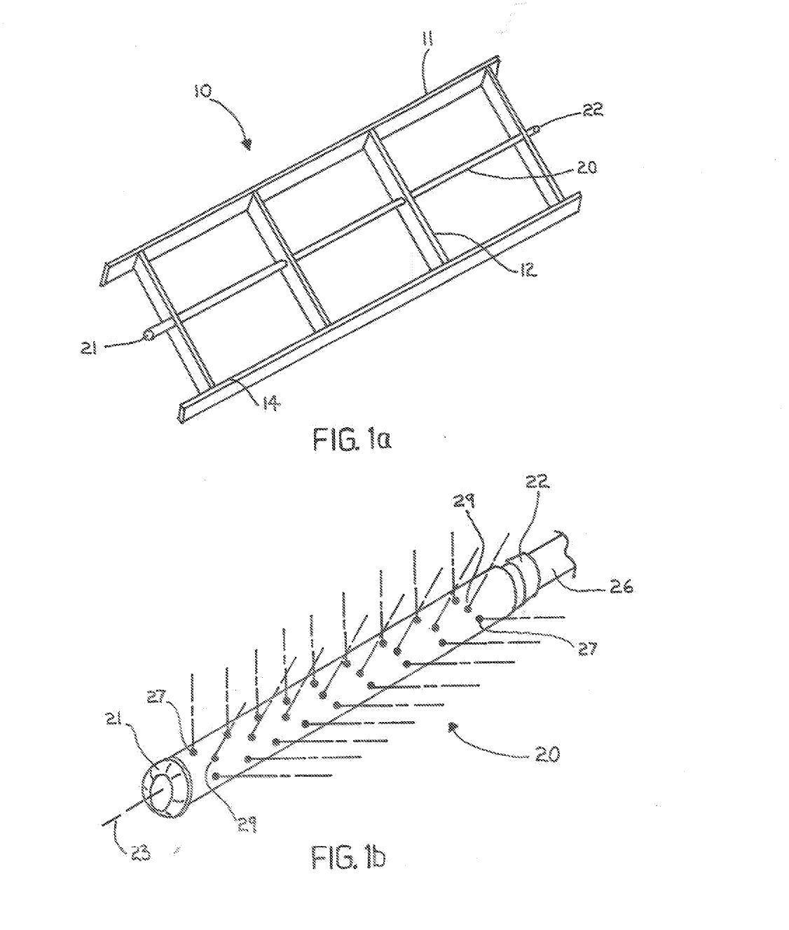

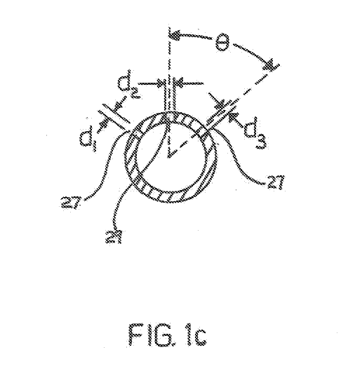

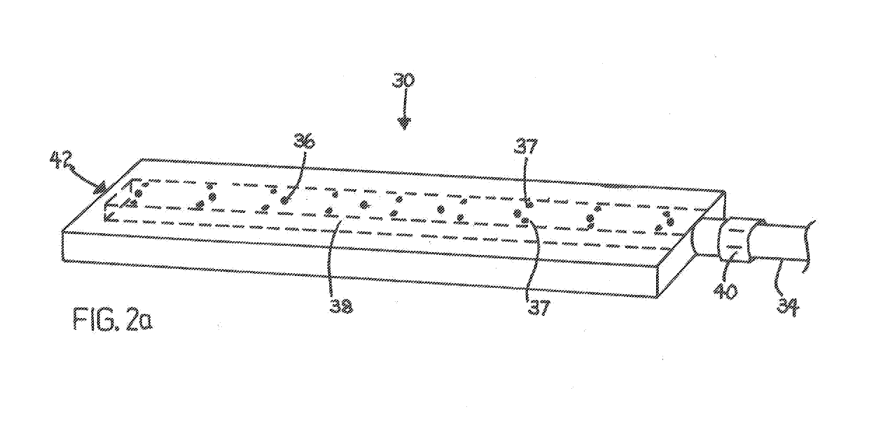

Referring now to the drawings, preferred embodiments of the invention will now be described in more detail. FIG. 1a depicts an embodiment of the invention generally comprising a multi-beam frame 10. In this embodiment, the device includes a plurality of primary 11 and secondary 12 beams that provide a means to stabilize the device vis-à-vis a mower being cleaned, and support it during use.

Preferably, the multi-beam frame embodiment of the device is generally square or rectangular in shape, comprising a plurality of primary and secondary beams that are from about 2 inches to about 4 inches in height, preferably about 2 inches. Most preferably, the multi-beam device comprises two primary beams being about 54 inches wide, and from two to four secondary beams that are about 22 inches wide. Particularly preferred beams are from about 0.5 inches to about 1 inch in thickness. The beams have a top edge 14, some portion of which generally makes contact with the mower deck when the latter is lowered onto the device during use.

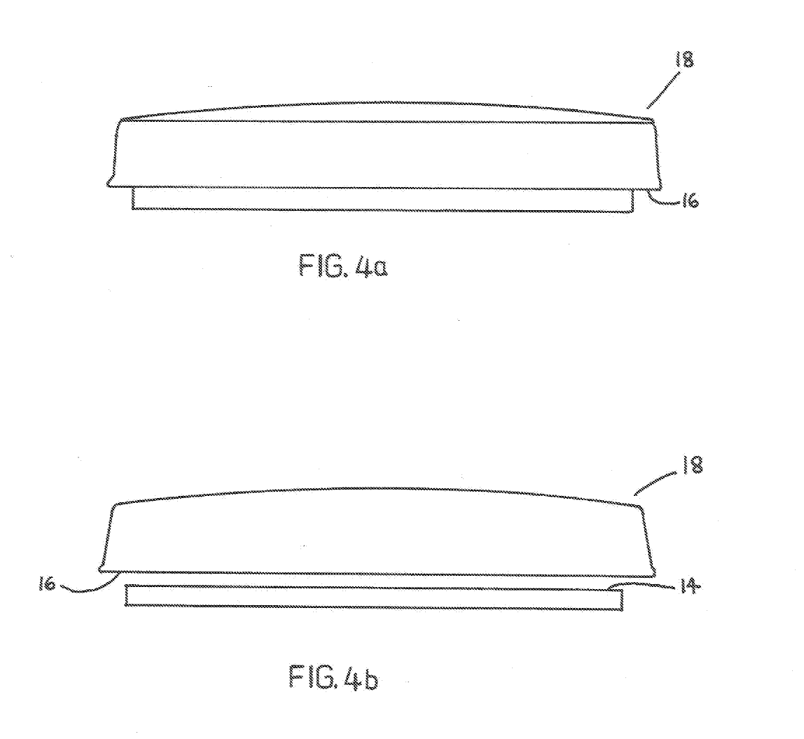

FIGS. 4a and 4b further depict this aspect of the invention. For example, with reference to the multi-beam embodiment, the top edge 14 of the multi-beam frame structure makes contact with the bottom edge of the mower deck 16 during use. FIG. 4a shows a schematic front view of the device in use with the deck lowered onto a beam of the device. FIG. 4b shows the relationship of the device to the mower prior to lowering the deck onto the device. As a result of the contact between the device and a mower deck during use, the weight/mass of the mower tends to force the device in a downward direction, preventing the device from shifting during use.

Referring again to FIG. 1, the device further includes a water conduit 20 which includes an intake port 22 at one end which is adapted to be connected to a hose or other means for tapping into a pressurized water supply, for example a home water supply. At the other end, the water conduit 20 terminates at a capped end 21, or otherwise terminates to provide a fixed length conduit. As depicted in FIG. 1b, the water conduit 20 has a longitudinal axis 23. The conduit 20 further comprises a plurality of water outlet holes. FIG. 1b shows a close-up perspective view of the water conduit 20 and water outlet holes. The water outlet holes are distributed along the length of the water conduit running parallel to the longitudinal axis 23 to provide a plurality of vertically and/or angularly directed streams of pressurized water to the under deck region of a mower. In one embodiment of this aspect of the invention, water conduit 20 includes a plurality of outlet holes that are configured to project a plurality of water streams in a vertically upward direction 29 and in an angularly upward direction 27.

Water conduit 20 can include any number of water outlet holes, generally between 5 to about 40 in number. Preferably, water conduit 20 includes from about 8 to about 9 vertically-oriented outlet holes 29, that are distributed along a top side of the water conduit running parallel with longitudinal axis 23 of the conduit and further including from about 16 to about 18 angularly-oriented outlet holes 27, about 8 to 9 of which are distributed along each of two rows that run parallel with longitudinal axis 23 at an angle θ from the vertical, as depicted in FIG. 1c.

Because the device is designed to be used with a mower while the engine is engaged and the blades are spinning, it is preferred that water outlet holes not be present near either end of the water conduit. In particular, it is desirable to have a region at both ends of water conduit 20 of from about 5 inches to about 10 inches, preferably about 7 inches, which region does not have water outlet holes. This dead space region is useful in preventing excess water from being sprayed beyond the mower. The device of the present invention can accommodate a range of tractor mowers having decks of different sizes. The device generally has dimensions that allow it to substantially fit underneath a tractor mower deck when properly placed for use. The device is capable of handling even the largest decks because the water sprayed from the outlet holes is propelled centrifugally toward the outer edges of the deck by the wind force generated by the spinning blades.

FIG. 1c shows a cross-sectional view of water conduit 20. Angularly-directed water outlet holes 27 and vertically-directed outlet holes 29 are defined by diameters d1, d2 and d3, and by angle θ between the vertical direction (vertically-oriented holes 29) and angularly-oriented holes 27. The diameters of the outlet holes (d1-d3), generally, though not necessarily, would be the same and are important in determining the level of pressure in the water streams. The amount of pressure in the water can impact the effectiveness and quality of the cleaning that results, and would desirably be sufficient to remove caked-on grass and other debris within a reasonable time period, for example, from about 10 minutes to about 20 minutes with the mower engine at half-throttle. If the diameter of the outlet holes is too large, insufficient pressure will be realized, and vice versa. Preferably, the water outlet hole diameters d1-d3 would be in a range of about 1/16 inch to about 3/32 inch. The angle θ preferably would be less than 45°; more preferably from about 30° to less than 45°. This angle is important in ensuring that adequately pressurized water is directed toward the outer edges of the deck where much of the grass and debris collects during use of the mower to cut grass, thereby ensuring a complete cleaning of the under deck region of the mower.

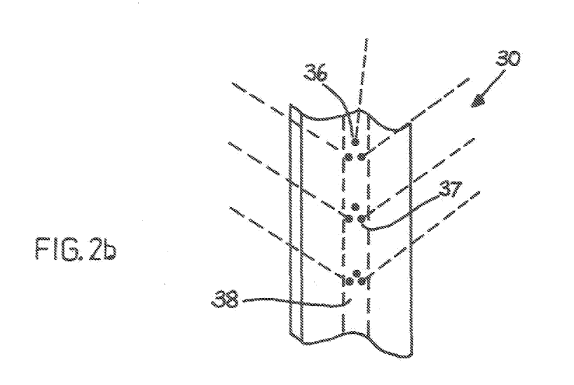

Another embodiment of the invention is depicted in FIG. 2. As shown in FIG. 2a, this embodiment comprises a single-beam frame 30. In one aspect of this embodiment, a water conduit 38 is embedded within the beam structure 30. In another aspect of this embodiment, the water conduit 38 comprises an internal chamber or hollow region of the beam, creating a hollow, tubular or rectangular cross section. For example, construction of this embodiment can be from hollow structural section. One end of the water conduit 38 of this embodiment is equipped with an adapter 40 to enable connection to a garden hose 34. The other, distal end 42, is closed. In this embodiment, a plurality of vertically-oriented 36 and angularly-oriented water outlet holes 37 penetrate through the beam structure and into the embedded water conduit 38. Preferably, the angularly-oriented water outlet holes straddle the vertically-oriented holes as depicted in FIG. 2b. Thus, with pressurized water flowing to the device, a plurality of water streams are projected outward from the water conduit 38, through the holes in the beam to the outside environment. Advantageously, this embodiment can be used on a hard, paved surface, or on the grass.

Preferably, the water outlet holes in the single-beam embodiment are positioned to project water streams vertically and angularly, from about 30° to about 45° outward from the top vertical direction. In a further aspect of this embodiment, the outlet holes are preferably distributed along three rows running parallel to the longitudinal axis of the water conduit, one center row and two rows on either side of the center row. Preferably, about 6-10 outlet holes are distributed along each of the three rows; most preferably 9 outlet holes are placed along each of the two outward, angularly-oriented rows, and 8 outlet holes along the center, vertically-oriented row. Preferably the outlet holes are from about 1/16 inch to about 3/32 inch in diameter.

A device of the invention can be constructed from readily-available, low-cost, materials including, for example, wood, plastic and metal. Preferably, the materials used in constructing the device are water-resistant. For example, in a preferred embodiment of the multi-beam device depicted in FIG. 1, the water conduit 20 is constructed from plastic pipe material such as PVC pipe of a suitable diameter, preferably from about 0.5 inches to about 1 inch in diameter, and having a wall thickness of from about 0.1 inches to about 0.2 inches. One end of the water conduit 20 is capped using any readily available cap or plug. The single-beam embodiment as depicted in FIG. 2 can be made from any suitable board material, preferably from a thermoplastic or composite board material. A particularly convenient material for constructing a single-beam device according to the invention is a deck composite hollow board material. Such material can be purchased having one or more hollow chambers running the length of the board, one of which can serve as the water conduit of the device. If additional hollow chambers are present they can be covered or otherwise sealed using any suitable means, for example, capping, covering, or filling with a sealant.

FIG. 1 shows that water sprays vertically and angularly in an upward direction a distance that is desirably from about 5 feet to about 10 feet when the device is connected to a pressurized water supply. The pressure is desirably maintained to provide adequate cleaning capacity. Both the number of outlet holes and their diameter will affect the resulting pressure. Including more outlet holes in the water conduit will result in a decrease in water pressure and vice versa. If the water supply pressure is low, and insufficient pressure is realized for a given number of outlet holes, the device can be easily modified to address this, for example, by closing off one or a plurality of outlet holes, by any suitable means known to the skilled artisan, thereby increasing the pressure of the streams of water emanating from the outlet holes.

The device of the present invention will accommodate tractor mowers of any size deck, including decks from 38 inches up to 52 inches. The multi-beam embodiment is preferably used on a hard, paved surface while the single-beam embodiment can be used on a hard surface or on grass.

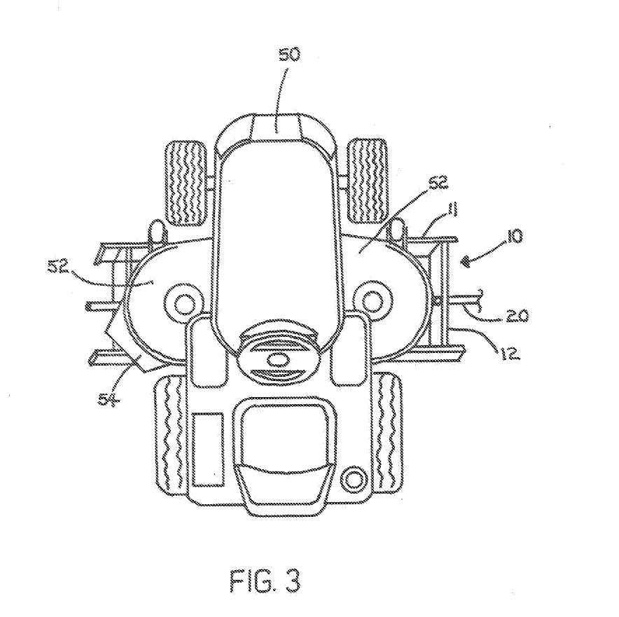

FIG. 3 depicts a tractor mower 50 positioned over a multi-beam frame embodiment of the invention 10. In this position, water conduit 20 sprays water directly upward into the underside of the mower deck 52. Located on the left side of the mower is a grass discharge chute 54. To use the multi-beam frame device, the operator drives the mower onto a hard surface, for example a paved surface, and then slides the device beneath the mower to center the device under the mower deck. The operator then sets the brake and lowers the deck onto the washer with chute in the down position. The device is attached to a garden hose and the water turned on. The operator then starts the tractor engine, engages the blades at about half speed and lets the cleaning operation proceed for about 10 minutes to about 15 minutes. If the grass was wet when cut, additional time may be required for a thorough cleaning. The result is that the combined action of the spray and the rotating action of the blades thoroughly cleans the underside of the lawn mower.

Use of a single-beam embodiment to clean a mower deck is generally as follows. The device is placed either on the grass or on a hard surface. The device can be slid under the mower to center it beneath the deck, or the mower operator can drive the mower over the device centering the device under the mower deck. The operator then sets the brake and lowers the deck onto the washer with chute in the down position. The device is attached to a garden hose and the water turned on. The operator then starts the tractor engine, engages the blades at about half speed and lets the cleaning operation proceed for about 10 minutes to about 15 minutes. If the grass was wet when cut additional time may be required for a thorough cleaning.

1. A tractor mower under deck cleaning device comprising a water conduit and a stabilization means wherein said water conduit comprises a plurality of angularly-oriented water outlet holes that produce a plurality of water streams projecting outward from said conduit when pressurized water is delivered to said water conduit, and wherein said stabilization means comprises at least one beam that cooperatively interacts with the under deck of the mower during use.

2. The device of claim 1 wherein said conduit further comprises a plurality of vertically-oriented water outlet holes.

3. The device of claim 2 wherein said stabilization means comprises two primary beams and at least two secondary beams.

4. The device of claim 3 wherein said stabilization means defines a rectangular frame comprising two primary beams and 4 secondary beams.

5. The device of claim 4 wherein said water conduit contains nine vertically-oriented water outlet holes.

6. The device of claim 5 wherein said water conduit contains eighteen (18) angularly-oriented water outlet holes.

7. (canceled)
